(19) United States
(12) Patent Application Publication
(10) Pub. No.: US 2017/0234977 A1
(43) Pub. Date: Aug. 17, 2017

(54) LIDAR SYSTEM AND MULTIPLE DETECTION SIGNAL PROCESSING METHOD THEREOF

(71) Applicant: ELECTRONICS AND TELECOMMUNICATIONS RESEARCH INSTITUTE, Daejeon (KR)

(72) Inventor: Jong Deog KIM, Daejeon (KR)

(21) Appl. No.: 15/232,716

(22) Filed: Aug. 9, 2016

(30) Foreign Application Priority Data
Feb. 17, 2016 (KR) 10-2016-0018306

(51) Int. Cl. G01S 7/487

(52) U.S. Cl. CPC G01S 7/4876

(57) ABSTRACT

Disclosed are a lidar system and a multiple detection signal processing method thereof. A multiple detection signal processing method includes outputting a plurality of transmitted signals having different wavelengths into a space according to a preset time difference, receiving a plurality of received signals received by reflecting the plurality of transmitted signals from circumferential objects, and filtering, as interference/noise signals, received pulse signals that have not a preset threshold time interval with an arbitrary received signal among the plurality of receive signals.

### CROSS-REFERENCE TO RELATED APPLICATION

The present application claims priority to Korean patent application number 10-2016-0018306 filed on Feb. 17, 2016 the entire disclosure of which is incorporated herein in its entirety by reference.

### BACKGROUND

1. Field

An aspect of the present disclosure relates to a lidar system and a multiple detection signal processing method thereof.

2. Description of the Related Art

As shapes and positions of objects being distributed in a space are detected in real time, more intelligent devices and services have recently been developed. A lidar system (lidar sensor) using light detects information on a positions and a moving velocity of an object in a still or moving state, which exists in a circumferential space, and acquires information on a two-dimensional distribution or a three-dimensional shape of the object.

In a lidar system using a time of flight (ToF) scheme, such as a laser scanner or a flash lidar, when a transmitted laser pulse beam is multiply reflected or scattered to be incident to a receiver, a data point of a received signal includes information different from the true data point. When a plurality of such information are included, a distortion occurs in two-dimensional/three-dimensional image information. In addition, the receiver in the lidar system has noises due to various causes such as a kind of device, a semiconductor process, and an operating condition. Particularly, the flash lidar is configured with a plurality of receiving device cells and hence exhibits a characteristic that is weaker to such noises. Therefore, a plurality of noise points are included in a received image signal.

A typical lidar system does not have a means for distinguishing a signal caused by noise/interference from a normal signal. Therefore, in order to implement a vehicle system requiring high safety, an appropriate signal processing means capable of distinguishing a signal caused by noise/interference from a normal pulse signal is required in the lidar system.

### SUMMARY

Embodiments provide a lidar system using a time of flight (ToF) scheme, which detects a distance, a velocity, and a shape with respect of object existing in a three-dimensional space using laser or light scheme, and a multiple detection signal processing method of the lidar system, which can prevent mutual interference caused by a noise or a signal input from another adjacent lidar system.

According to an aspect of the present disclosure, there is provided a multiple detection signal processing method including: outputting a plurality of transmitted signals having different wavelengths into a space according to a preset time difference; receiving a plurality of received signals received by reflecting the plurality of transmitted signals from circumferential objects; and filtering, as interference/noise signals, received pulse signals that have not a preset threshold time interval with an arbitrary received signal among the plurality of receive signals.

According to an aspect of the present disclosure, there is provided a multiple detection signal processing apparatus including: a transmitting unit configured to output a plurality of transmitted signals having different wavelengths into a space according to a preset time difference; a receiving unit configured to receive a plurality of received signals received by reflecting the plurality of transmitted signals from circumferential objects; and a signal processing and control unit configured to filter, as interference/noise signals, received pulse signals that do not have a preset threshold time interval with an arbitrary received pulse signal among the plurality of received signals.

### BRIEF DESCRIPTION OF THE DRAWINGS

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the example embodiments to those skilled in the art.

In the drawing figures, dimensions may be exaggerated for clarity of illustration. It will be understood that when an element is referred to as being “between” two elements, it can be the only element between the two elements, or one or more intervening elements may also be present. Like reference numerals refer to like elements throughout.

FIGS. 1 and 2 are diagrams illustrating configurations of general lidar systems.

FIG. 3 is a diagram illustrating a multiple detection signal processing method in the general lidar system.

FIG. 4 is a diagram illustrating a multiple detection signal processing method in a lidar system to which the present disclosure is applied.

FIG. 5 is a diagram illustrating a method of setting a threshold time interval in the lidar system to which the present disclosure is applied.

FIG. 6 is a diagram illustrating a method of setting wavelengths of a plurality of transmitted signals in the lidar system according to the present disclosure.

FIG. 7 is a diagram illustrating a configuration of the lidar system according to the present disclosure.

### DETAILED DESCRIPTION

The present disclosure now will be described more fully hereinafter with reference to the accompanying drawings, in which embodiments of the present disclosure are shown. The present disclosure should not be construed as limited to the embodiments set forth herein. Rather, these embodiments are provided so that this disclosure will be thorough and complete, and will fully convey the scope of the present disclosure to those skilled in the art.

It will be further understood that the terms “includes” and/or “including”, when used in this specification, specify the presence of stated features, integers, steps, operations, elements, and/or components, but do not preclude the presence and/or addition of one or more other features, integers, steps, operations, elements, components, and/or groups thereof.

As used herein, the singular forms are intended to include the plural forms as well, unless the context clearly indicates otherwise.

Hereinafter, exemplary embodiments of the present disclosure will be described in detail with reference to the accompanying drawings.

In general, a lidar system uses a time of flight (ToF) scheme in which a distance is obtained by transmitting, in the form of a pulse, a laser point beam having an infrared wavelength or a visible wavelength, and measuring reception times of pulse signals reflected or scattered from circumferential objects. Representative examples of current lidar systems for acquiring three-dimensional images using the ToF scheme are a laser scanner and a flash lidar.

The laser scanner quickly rotates or performs line-scanning in a two-dimensional or three-dimensional space using one or a plurality of laser point beams. A current laser scanner may collect point cloud data on circumferential objects at a velocity of about a few tens of frames per second.

The flash lidar irradiates a laser pulse beam to be widely diffused in a space, similarly to a camera flash light, and receives signals reflected or scattered to be received from circumferential objects using a focal plane array (FPA) receiver configured with a lens and a plurality of receiving device cells. Unit cells in the receiver individually measure times and signal intensity changes from generation of a laser pulse beam to reception of a received pulse signal, thereby collecting point cloud data for a three-dimensional image of the circumferential objects distributed in the space.

A lidar sensor is one of main smart sensors expected that their use will be gradually increased together with the spread of unmanned autonomous vehicles in the near future. If the rate at which lidar sensors are to be equipped in various vehicles is continuously increased hereafter, information errors caused by interference between the lidar sensors will become an important issue that hampers safety in intelligent vehicles based on the lidar sensors.

Meanwhile, in a lidar system using the ToF scheme, such as a laser scanner or a flash lidar, when a transmitted laser pulse beam is multiply reflected or scattered to be incident to a receiver, a data point of a received signal includes information different from the true data point. When a plurality of such information are included, a distortion occurs in two-dimensional/three-dimensional image information. In addition, the receiver in the lidar system has noises due to various causes such as a kind of device, a semiconductor process, and an operating condition.

Particularly, the flash lidar is configured with a plurality of receiving device cells and hence exhibits a characteristic that is weaker to such noises. Therefore, a plurality of noise points are included in a received image signal.

The typical lidar system does not have a means for distinguishing a signal caused by noise/interference from a normal signal. Therefore, in order to implement a vehicle system requiring high safety, an appropriate signal processing means capable of distinguishing a signal caused by noise/interference from a normal pulse signal is required in the lidar system.

This will be described in detail with reference to the accompanying drawings.

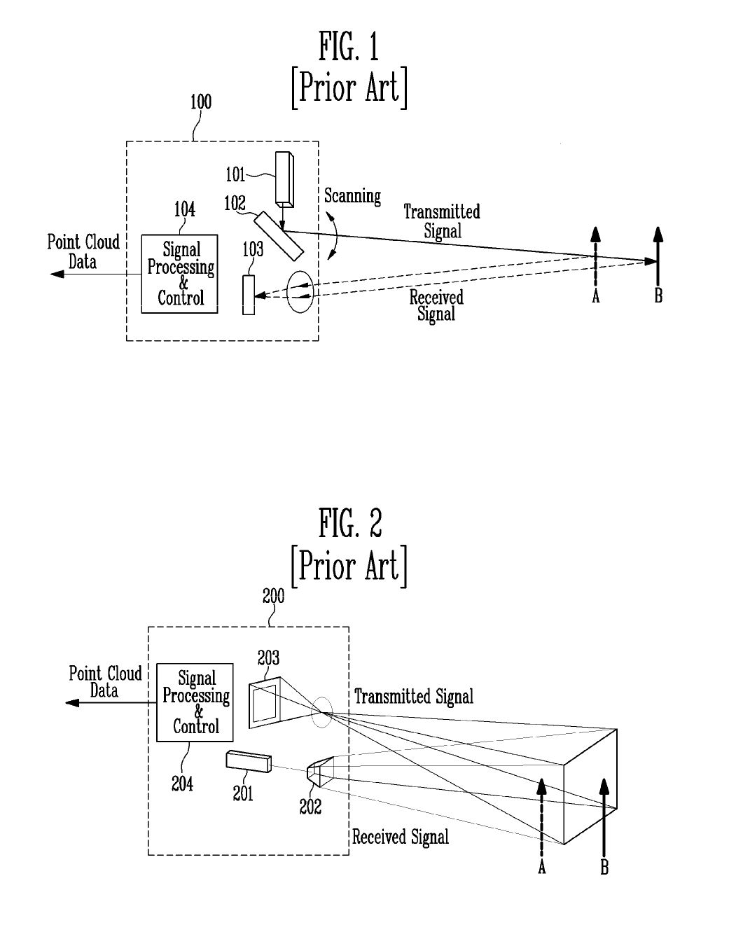

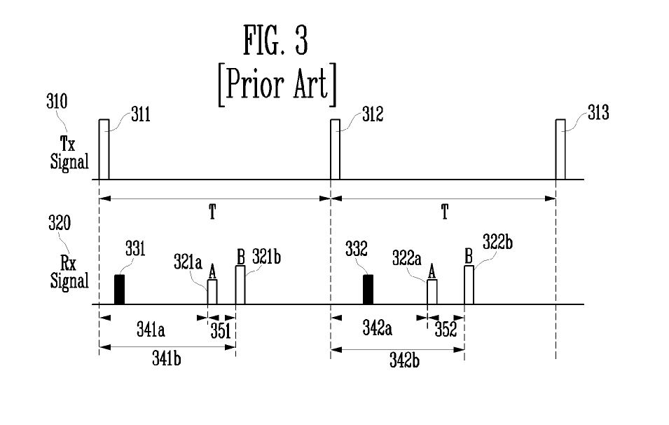

FIGS. 1 and 2 are diagrams illustrating configurations of general lidar systems. FIG. 1 is a view illustrating a laser scanner among the lidar systems, and FIG. 2 is a view illustrating a flash lidar among the lidar systems.

Referring to FIG. 1, the laser scanner 100 irradiates a laser point beam (pulse signal) having a single wavelength, which is output in the form of a pulse from a laser transmitter 101, into a two-dimensional or three-dimensional space using a mirror scanner 102 having a single axis or two axes, thereby scanning circumferential objects.

In various embodiments, the laser scanner 100 may be configured to include, instead of the mirror scanner 102, a plurality of laser transmitters arranged to face at different angles and a plurality of receivers corresponding to the respective transmitters. The laser scanner 100 may scan circumferential objects by rotating at 360 degrees.

The laser point beam irradiated into the scanning space is reflected or scattered by objects A and B existing in the space to be incident in the form of a pulse (pulse signal) to a receiver 103. A signal processing and control unit 104 of the laser scanner 100 detects intensities and ToFs of received signals incident to the receiver 103, thereby outputting point cloud data.

In FIG. 1, a portion of the output laser point beam may be reflected or scattered by the object A, such as glass or curtain, which has semipermeability with respect to the wavelength of the laser point beam, to be received to the receiver 103. The rest of the laser point beam may be transmitted through the object A having semipermeability and then secondarily reflected or scattered by the object B having impermeability to be received to the receiver 103.

Referring to FIG. 2, the flash lidar 200 widely spreads a laser beam (pulse signal) output in the form of a pulse from a single laser transmitter 201 using a beam spreader 202 and irradiates the spread laser beam into a space to be detected. The flash lidar 200 detects signals (pulse signals) reflected or scattered to be received from objects in the space into which the laser beam is irradiated, using an array 203 of receivers. The array 203 of receivers in the flash lidar 200 may be one integrated with a plurality of unit cells, such as a CMOS image sensor.

A signal processing and control unit 204 of the flash lidar 200 individually detects intensities and ToFs of received signals with respect to the plurality of unit cells constituting the array 203 of receivers, so that it is possible to quickly create point cloud data on a three-dimensional space.

In FIG. 2, like FIG. 1, objects A and B are a semipermeable object A and an impermeable object B.

In various embodiments, a lidar system implemented as a laser scanner or a flash lidar as shown in FIGS. 1 and 2 performs processing on multiple detection signals received to a receiver, thereby creating point cloud data on a three-dimensional space.

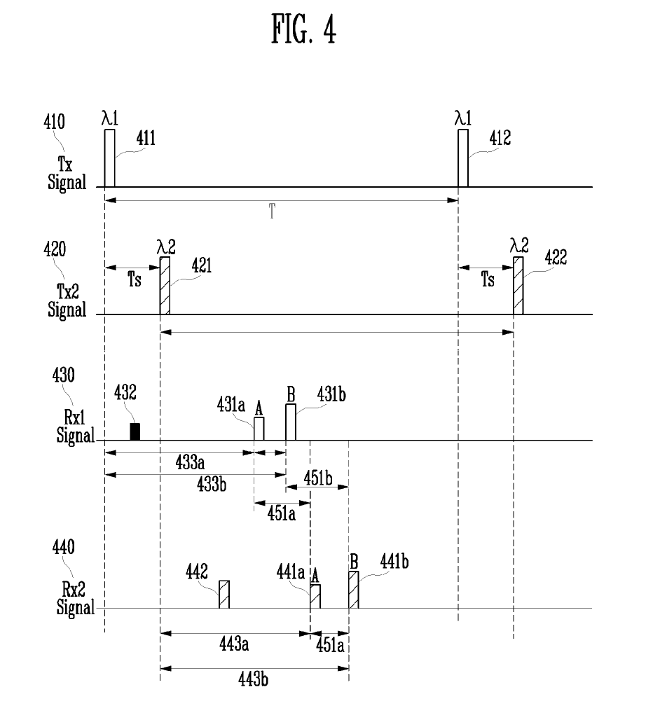

In the general lidar system, the lidar system measures a ToF between a transmitter Tx and a receiver Rx in a manner shown in FIG. 3.

Referring to FIG. 3, in the lidar system, a transmitted signal 310 is configured with transmitted pulse signals 311, 312, and 313 that have a series of single wavelengths having a constant pulse period T as described above. In this case, one time interval T may form one time frame.

As the transmitted signal 310 is configured with the transmitted pulse signals 311, 312, and 313, a received signal 320 to which the transmitted signal 310 is reflected or scattered received by reflecting or scattering the transmitted signal 310 from circumferential objects A and B is also configured with received pulse signals 312a, 312b, 322a, and 322b.

Time intervals 341a and 341b from a transmission time of the transmitted pulse signal 311 to reception times of the received pulse signals 321a and 321b in a first time frame refer to times required for the transmitted pulse signal 311 in the first time frame to make a round trip from the lidar system to the object A and the impermeable object B, i.e., pulse round trip times with respect to the objects A and B.

Similarly, time intervals 342a and 342b from a transmission time of the transmitted pulse signal 312 to reception times of the received pulse signals 322a and 322b in a second time frame refer to times required for the transmitted pulse signal 312 in the second time frame to make a round trip from the lidar system to the object A and the impermeable object B, i.e., pulse round trip times with respect to the objects A and B.

Here, a relative velocity v between the lidar system and the object A is 0 (v=0). However, if the relative velocity v between the lidar system and the object A is greater than 0 (v>0), the pulse round trip time 341a with respect to the object A in the first time frame and the pulse round trip time 342a with respect to the object A in the second time frame are equal to each other. On the other hand, the pulse round trip time 341b with respect to the object B in the first time frame and the pulse round trip time 342b with respect to the object B in the second time frame may be different from each other.

Thus, a moving velocity between the two objects A and B can be measured by considering differences 351 and 352 between the pulse round trip times with respect to the two objects A and B in the different time frames, a directional characteristic, and a velocity of the lidar system.

Meanwhile, in the lidar system, the received signal 320 may include interference signals or noise signals 331 and 332 caused by another lidar system using a laser beam having the same wavelength. The general lidar system does not have a method capable of distinguishing the interference/noise signals 331 and 332 from the normal received pulse signals 321a, 321b, 322a, and 322b. Such an interference/noise signal causes an error in the measurement of a distance from the lidar system to an object, and a distance measurement error caused by mutual interference between two laser scanners is most severe when the two laser scanners face each other.

If such an interference effect cannot be neglected even in laser scanners using point beams, flash lidars using a beam spreading scheme cause larger mutual interference with respect to circumferential lidar systems.

Therefore, in order to implement a vehicle system requiring higher safety, there is required a multiple detection signal processing method capable of distinguishing normal received pulse signals from interference/noise signals in the lidar system.

Accordingly, in the present disclosure, there is provided a multiple detection signal processing method capable of distinguishing normal received pulse signals from interference/noise signals.

FIG. 4 is a diagram illustrating a multiple detection signal processing method in a lidar system to which the present disclosure is applied.

Referring to FIG. 4, the lidar system according to the present disclosure irradiates a plurality of pulse signals having different wavelengths into a space and detects received pulse signals of the irradiated pulse signals, thereby processing multiple detection signals.

Specifically, the lidar system according to the present disclosure is configured with a plurality of transmitters that have different wavelengths A1 and A2 but are output pulse signals having the same path at different times. Accordingly, a transmitted signal is configured with a plurality of transmitted signals 410 and 420 that have different wavelengths A1 and A2 and are output at different times.

Referring to FIG. 4, a first transmitted signal 410 is configured with first transmitted pulse signals 411 and 412 having a wavelength A1, which are generated according to a constant pulse period T, and a second transmitted signal 420 is configured with second transmitted pulse signals 421 and 422 having a wavelength A2, which are generated according to the same pulse period T. Here, the second transmitted pulse signals 421 and 422 have an arbitrary time difference Ts with the first transmitted pulse signals 411 and 412.

Each of the plurality of transmitted signals 410 and 420 output from the lidar system is reflected or scattered from circumferential objects A and B to be received to the lidar system. A plurality of received signals 430 and 440 respectively corresponding to the plurality of transmitted signals 410 and 420 are received up to the lidar system through the same path, but have different wavelengths, corresponding to the respective transmitted signals 410 and 420. Thus, the lidar system according to the present disclosure is configured with a plurality of receivers detecting different wavelengths A1 and A2.

Referring to FIG. 4, a first received signal 430 corresponding to the first transmitted signal 410 is configured with first received pulse signals 431a and 431b respectively received by reflecting or scattering the first transmitted pulse signals 411 and 412 from the circumferential objects A and B. Time intervals 433a and 433b from a transmission time of the first transmitted pulse signal 411 to reception times of the first received pulse signals 431a and 431b in a first time frame refer to times required for the first transmitted pulse signal 411 in the first time frame to make a round trip from the lidar system to the object A and the impermeable object B, i.e., pulse round trip times with respect to the objects A and B.

Similarly, a second received signal 440 corresponding to the second transmitted signal 420 is configured with second received pulse signals 441a and 441b respectively received by reflecting or scattering the second transmitted pulse signals 421 and 422 from the circumferential objects A and B. Time intervals 443a and 443b from a transmission time of the second transmitted pulse signal 421 to reception times of the second received pulse signals 441a and 441b in a second time frame refer to times required for the second transmitted pulse signal 421 in the second time frame to make a round trip from the lidar system to the object A and the impermeable object B, i.e., pulse round trip times with respect to the objects A and B.

FIG. 4 may include both a case the circumferential objects are in a still state and a case where the circumferential objects are in a moving state.

If it is assumed that the object A is in the still state with respect to the lidar system and the object B is in the moving state in which it moves in a direction distant from the lidar system, the object B moves in the direction distant from the lidar system for the time difference Ts between the first transmitted pulse signal 411 and the second transmitted pulse signal 421 in the first time frame.

Accordingly, the round trip time 443b of the second transmitted pulse signal 412 with respect to the object B in the first time frame will be measured larger than the round trip time 433b of the first transmitted pulse signal 411 with respect to object B in the first time frame.

A desired maximum measurement distance of a vehicle lidar system is within a few hundreds of meters, and a time required for a pulse signal of a laser point beam to make a round trip to the distance is within about a few μs. For example, when a desired maximum measurement distance of the vehicle lidar system is 200 m, a time required for the pulse signal to make a round trip to about 200 m is 1.33 μs. A distance where a vehicle driven at a relative velocity of 300 km/h moves for the time is about 111 gm. Therefore, for the object A of which relative velocity is 0 with respect to the lidar system and the object B of which relative velocity is 300 km/h with respect to the lidar system, the round trip time 433b of the first transmitted pulse signal 411 with respect to the object B in the first time frame of FIG. 4 and the round trip time 443b of the second transmitted pulse signal 421 with respect to the object B in the first time frame of FIG. 4 have a difference of about 0.37 psec.

Even when a difference in relative velocity between the two objects with respect to the lidar system is equal to or greater than two times, i.e., when a relative velocity of the object B with respect to the lidar system is equal to or greater than 600 km/h, the round trip time 433b of the first transmitted pulse signal 411 with respect to the object B in the first time frame and the round trip time 443b of the second transmitted pulse signal 421 with respect to the object B in the first time frame have a difference of less than 1 psec. Thus, in the lidar system using the ToF scheme, which has a distance resolution performance of cm or so, a difference between the round trip time 433b of the first transmitted pulse signal 411 with respect to the object B in the first time frame and the round trip time 443b of the second transmitted pulse signal 421 with respect to the object B in the first time frame can be neglected.

Consequently, in FIG. 4, when a condition that the time difference Ts between the transmitted signals 410 and 420 is within the round trip time of the pulse signal with respect to the maximum measurement distance, regardless of the pulse period T of the plurality of transmitted signals 410 and 420, a time interval 451a between the first and second received pulse signals 431a and 441a with respect to the object A and a time interval 451b between the first and second received pulse signals 431b and 441b are equal to each other within an allowable error.

Thus, the plurality of normal received signals 430 and 440 that are directly reflected or scattered from the objects A and B without passing through multiple paths to be directly received to the receiver without passing through multiple paths are detected at a time interval corresponding to the time difference Ts between the plurality of transmitted signals 410 and 420±the allowable error. That is, received pulse signals with respect to the same object have a time interval of the time difference Ts between the plurality of transmitted signals 410 and 420±the allowable error.

According to this principle, in FIG. 4, the other received pulse signals 432 and 442 except the received pulse signals having the time interval corresponding to the time difference Ts between the plurality of transmitted signals 410 and 420±the allowable error may be filtered as abnormal signals caused by interference/noise.

Hereinafter, a method of setting the time difference Ts between the plurality of transmitted signals 410 and 420 and the time difference Ts between the plurality of transmitted signals 410 and 420±the allowable error in processing of multiple detection signals according to the above-described principle will be described in detail. Hereinafter, the time difference Ts between the plurality of transmitted signals 410 and 420±the allowable error will be referred to as a threshold time interval.

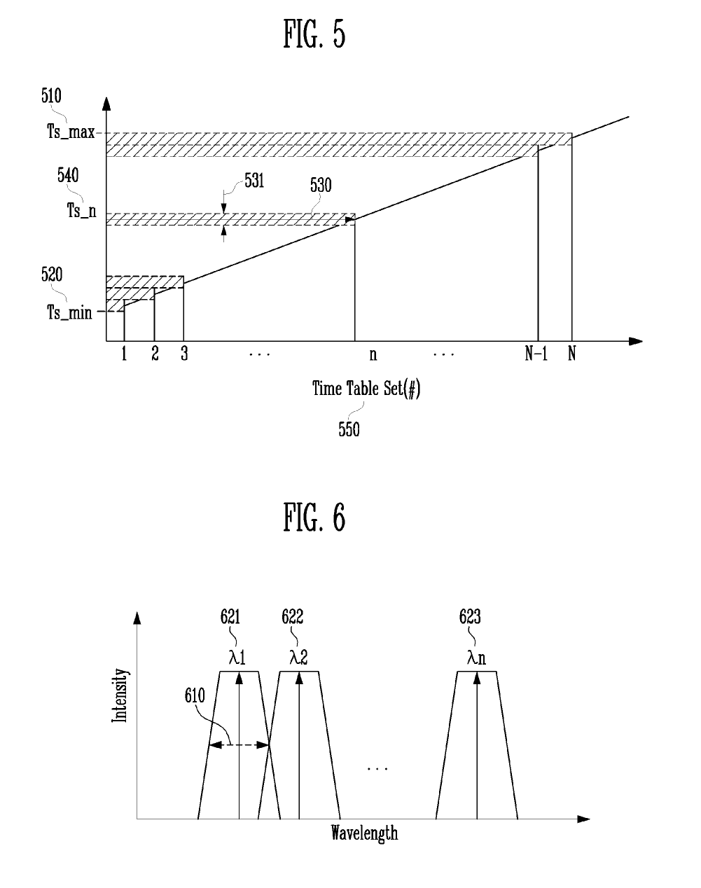

FIG. 5 is a diagram illustrating a method of setting a threshold time interval in the lidar system to which the present disclosure is applied. In various embodiments, the lidar system may set a time difference Ts between the plurality of transmitted signals 410 and 420 and a threshold time interval corresponding thereto using the following method.

First, the lidar system, as shown in FIG. 5, sets a round trip time of a pulse signal with respect to a maximum measurement distance as a maximum value (Ts_max) 510 of the time difference Ts. Also, the lidar system sets a measurable minimum time interval as a minimum value (Ts_min) 520 of the time difference Ts in implementation of a multiple detection signal processing lidar system.

The lidar system may set, as the time difference Ts between the transmitted signals 410 and 420, an arbitrary value 530 between the maximum value (Ts_max) 510 of the time difference Ts and the minimum value (Ts_min) 520 of the time difference Ts. The lidar system may determine an allowable error 531 with respect to the arbitrary value 530 as a threshold time interval (Ts_n) 540.

The lidar system according to the present disclosure outputs the transmitted signals 410 and 420 at the time difference Ts corresponding to the determined arbitrary value 530. The lidar system considers, as received pulse signals caused by interference/noise, received pulse signals that do not have the predetermined threshold time interval (Ts_n) 540 with an arbitrary received pulse signal among the received signals 430 and 440, and filters the received pulse signals.

In various embodiments, the lidar system may divide a space between the maximum value (Ts_max) 510 and the minimum value (Ts_min) 520 at the allowable error 531, thereby creating and storing/managing a time table set 550 with respect to N threshold time intervals.

If a plurality of adjacent lidar systems randomly select threshold time intervals 540 on the basis of the time table set 550, the probability that the same threshold time interval 540 will be selected between the plurality of adjacent lidar system is decreased to 1/N.

Hereinafter, a method of setting wavelengths of the plurality of transmitted signals in the lidar system according to the present disclosure will be described.

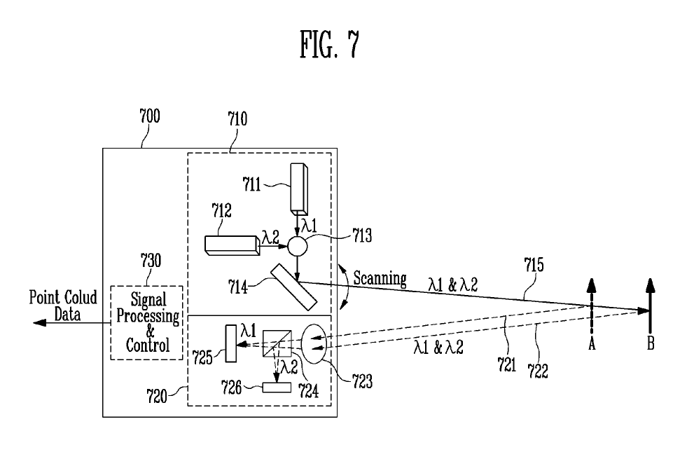

FIG. 6 is a diagram illustrating a method of setting wavelengths of a plurality of transmitted signals in the lidar system according to the present disclosure.

Referring to FIG. 6, the transmitter of the lidar system according to the present disclosure may select an arbitrary wavelength from a plurality of central wavelengths 621 to 623 having a preset wavelength allowable width 60. That is, the wavelengths of the plurality of transmitted signals 410 and 420 in the lidar system according to the present disclosure may be set to have different wavelengths among the plurality of central wavelengths 621 and 623 as shown in FIG. 6.

FIG. 7 is a diagram illustrating a configuration of the lidar system according to the present disclosure.

Referring to FIG. 7, the lidar system 700 according to the present disclosure includes a transmitting unit 710, a receiving unit 720, and a signal processing and control unit 730.

The transmitting unit 710 includes a plurality of transmitters 711 and 712 configured to output a plurality of pulse signals having different wavelengths X1 and X2 at different times having a preset time difference Ts. The transmitting unit 710 includes an optical coupler 713 provided on a path of pulse signals output from the plurality of transmitters 711 and 712, so that the pulse signals output from the plurality of transmitters 711 and 712 are coupled and output to have a single optical path. A pulse signal output through the optical coupler 713 is output such that an arbitrary point in a space can be point-scanned through a mirror scanner 714.

A transmitted signal 715 output through the mirror scanner 714 is a laser point beam including a plurality of transmitted signals as described in FIG. 4.

The plurality of transmitted signals are reflected or scattered from objects A and B in a space, and a plurality of received signals 721 and 722 reflected or scattered from the objects A and B are incident to the receiving unit 720 of the lidar system 700.

The plurality of received signals 721 and 722 incident to the receiving unit 720 are condensed through a lens 723 of the receiving unit 720. Then, each of the plurality of received signals 721 and 722 is divided into different wavelengths X1 and X2 through a wavelength division multiplexer (WDM) 724.

The plurality of received signals 721 and 722 having the divided different wavelengths X1 and X2 are incident to a plurality of receivers 725 and 726. In various embodiments, the plurality of receivers 725 and 726 may include an optical wavelength filter that allows only a wavelength component having a wavelength allowable width with respect to a selected specific wavelength among the central wavelengths shown in FIG. 6 to be transmitted therethrough.

The signal processing and control unit 730 controls the pulse signals output from the transmitting unit 710 and the mirror scanner 714, and processes signals received to the receiving unit 720 under the control thereof, so that finally detected space information is output in the form of point cloud data.

In signal processing, the signal processing and control unit 730, as described with reference to FIGS. 4 to 6, may set wavelengths of the transmitted signals and set a time difference Ts between the transmitted signals and a threshold time interval (Ts±allowable error) with respect to the received signals 721 and 722. Also, in the signal processing, the signal processing and control unit 730, as described with reference to FIGS. 4 to 6, may remove (filter) interference/noise signals from the received signals 721 and 722 using the set threshold time interval.

In FIG. 7, a case where the lidar system according to the present disclosure is configured as a laser scanner has been illustrated as an example, but the present disclosure is not limited thereto. As long as the multiple detection signal processing method according to the present disclosure is applied, the present disclosure may be configured in various forms including a flash lidar.

For example, in the lidar system 700 of FIG. 7, a beam spreader may be provided instead of the mirror scanner 714, and the plurality of receivers 725 and 726 may use a receiving device having a plurality of unit cells. Therefore, the lidar system according to the present disclosure may be configured in the form of a flash lidar.

In the lidar system and the multiple detection signal processing method thereof according to the present disclosure, it is possible to prevent distortion of image information, caused by noise in an environment inside or outside the lidar system, and to avoid interference between lidar systems.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present disclosure as set forth in the following claims.

What is claimed is:

1. A multiple detection signal processing method comprising:
outputting a plurality of transmitted signals having different wavelengths into a space according to a preset time difference;
receiving a plurality of received signals received by reflecting the plurality of transmitted signals from circumferential objects; and
filtering, as interference/noise signals, received pulse signals that have not a preset threshold time interval with an arbitrary received signal among the plurality of receive signals.

2. The multiple detection signal processing method of claim 1, wherein the plurality of transmitted signals are output through the same path in the space.

3. The multiple detection signal processing method of claim 1, wherein the plurality of transmitted signals configured as a plurality of pulse signals having a preset pulse period.

4. The multiple detection signal processing method of claim 1, wherein the plurality o received signals have different wavelengths corresponding to the different wavelengths of the plurality of transmitted signals.

5. The multiple detection signal processing method of claim 1, further comprising setting an allowable error with respect to the time difference as the threshold time interval.

6. The multiple detection signal processing method of claim 1, further comprising:
setting, a maximum value of the time difference, a round trip time with respect to a maximum measurement distance of an arbitrary transmitted pulse signal among the plurality of transmitted signals;
setting a measurable minimum time interval as a minimum value of the time difference; and
setting, as the time difference, an arbitrary value between the maximum value and the minimum value.

7. The multiple detection signal processing method of claim 6, further comprising setting, as the threshold time interval, an allowable error with respect to the arbitrary value.

8. The multiple detection signal processing method of claim 6, further comprising:
dividing a space between the maximum value and the minimum value at the allowable error; and
storing, in a time table set, N allowable errors formed in the dividing at N threshold time intervals.

9. The multiple detection signal processing method of claim 8, further comprising setting, as the threshold time interval, any one of the N threshold time intervals.

10. The multiple detection signal processing method of claim 1, further comprising selecting arbitrary wavelengths among a plurality of central wavelengths having a preset wavelength allowable width as the different wavelengths with respect to the plurality of transmitted signals.

11. The multiple detection signal processing method of claim 1, further comprising processing the plurality of filtered received signals, thereby outputting point cloud data on the circumferential objects.

12. A multiple detection signal processing apparatus comprising:
a transmitting unit configured to output a plurality of transmitted signals having different wavelengths into a space according to a preset time difference;
a receiving unit configured to receive a plurality of received signals received by reflecting the plurality of transmitted signals from circumferential objects; and
a signal processing and control unit configured to filter, as interference/noise signals, received pulse signals that do not have a preset threshold time interval with an arbitrary received pulse signal among the plurality of received signals.

13. The multiple detection signal processing apparatus of claim 12, wherein the transmitting unit includes:
a plurality of transmitters each configured to output the plurality of transmitted signals;
an optical coupler configured to couple the plurality of transmitted signals and output the plurality of transmitted signals through the same path; and
a mirror scanner configured to output the plurality of transmitted signal output from optical coupler as an arbitrary point in the space.

14. The multiple detection signal processing apparatus of claim 12, wherein the receiving unit includes:
a lens configured to condense the plurality of received signals;
a wavelength division multiplexer configured to divide the plurality of condensed received signals according to wavelengths; and
a plurality of receivers configured to respectively receive the plurality of divided received signals.

15. The multiple detection signal processing apparatus of claim 12, wherein the signal processing and control unit sets, as the threshold time interval, an allowable error with respect to the time difference.

16. The multiple detection signal processing apparatus of claim 12, wherein the signal processing and control unit sets, a maximum value of the time difference, a round trip time with respect to a maximum measurement distance of an arbitrary transmitted pulse signal among the plurality of transmitted signals, sets a measurable minimum time interval as a minimum value of the time difference, and sets, as the time difference, an arbitrary value between the maximum value and the minimum value.

17. The multiple detection signal processing apparatus of claim 16, wherein the signal processing and control unit sets, as the threshold time interval, an allowable error with respect to the arbitrary value.

18. The multiple detection signal processing apparatus of claim 16, wherein the signal processing and control unit divides a space between the maximum value and the minimum value at the allowable error, and stores, in a time table set, N allowable errors formed in the dividing at N threshold time intervals.

19. The multiple detection signal processing apparatus of claim 18, wherein the signal processing and control unit sets, as the threshold time interval, any one of the N threshold time intervals.

20. The multiple detection signal processing apparatus of claim 12, wherein the signal processing and control unit selects arbitrary wavelengths among a plurality of central wavelengths having a preset wavelength allowable width as the different wavelengths with respect to the plurality of transmitted signals.
